(19) United States
(12) Patent Application Publication
(10) Pub. No.: US 2023/0377069 A1
(43) Pub. Date: Nov. 23, 2023

(54) SYSTEM, METHOD, AND PROGRAM FOR SUPPORTING PURCHASE AND SALE OF REAL ESTATE

(71) Applicants: INNOVATION Co., Ltd, Tokyo (JP); KWC G.K., Tokyo (JP)

(72) Inventors: FUMIO SAKURAI, Tokyo (JP); NORIAKI MARUYAMA, Tokyo (JP)

(73) Assignees: INNOVATION Co., Ltd, Tokyo (JP); KWC G.K., Tokyo (JP)

(21) Appl. No.: 18/199,818

(22) Filed: May 19, 2023

(30) Foreign Application Priority Data
May 23, 2022 (JP) 2022-083875

(51) Int. Cl. G06Q 50/16

(52) U.S. Cl. CPC G06Q 50/16

(57) ABSTRACT

A system for supporting purchase and sale of real estate of the invention comprises: storage means for storing information indicating real estate on sale, the storage means storing, while associating, information indicating a true owner of the real estate, information indicating a contract signed for the real estate, and information indicating a revolving mortgage on the real state; receiving means for receiving a request to purchase the real estate from a user; rewriting means for rewriting the true owner of the real estate indicated by the information indicating the true owner to the user without changing registration of the real estate, without changing the contract, and without changing a holder of the revolving mortgage; and notification means for notifying the user that purchase of the real estate has been completed.

### CROSS-REFERENCE TO RELATED APPLICATIONS

This application claims priority to, and the benefit of, JP Patent Application No. 2022-083875, filed May 23, 2022 and titled “SYSTEM, METHOD, AND PROGRAM FOR SUPPORTING PURCHASE AND SALE OF REAL ESTATE,” which is incorporated by reference herein in its entirety for all purposes.

### FIELD

The present invention relates to a system, method, and program for supporting purchase and sale of real estate.

### BACKGROUND

Real estate may be purchased and sold for dwelling purposes, or purchased and sold for investment. A system for supporting investment in real estate is known (for example, Patent Literature 1).
[PTL 1] Japanese Laid-Open Publication No. 2003-331130

The inventors of the present invention considered that distribution of real estate would be promoted by enabling real estate to be more easily purchased and sold. In particular, the inventors considered that promoted distribution of real estate would increase the opportunities to invest in real estate and activate the market of investment in real estate.

The objective of the present invention is to provide a system or the like for supporting purchase and sale of real estate which can make purchase and sale of real estate easier.

### SUMMARY

For example, the present invention can provide a system, method, and program for supporting purchase and sale of real estate. For example, the present invention provides the following items.

(Item 1)

A system for supporting purchase and sale of real estate, comprising:
storage means for storing information indicating real estate on sale, the storage means storing, while associating, information indicating a true owner of the real estate, information indicating a contract signed for the real estate, and information indicating a revolving mortgage on the real state;
receiving means for receiving a request to purchase the real estate from a user;
rewriting means for rewriting the true owner of the real estate indicated by the information indicating the true owner to the user without changing real estate registration of the real estate, without changing the contract, and without changing a mortgagor of the revolving mortgage; and
notification means for notifying the user that purchase of the real estate has been completed.

(Item 2)

The system of the preceding item, wherein
the information indicating the contract includes information indicating a true contractor of the contract, and the information indicating the revolving mortgage includes information indicating a true mortgagor of the revolving mortgage, and
the system further comprises:
second rewriting means for automatically rewriting
(1) the true contractor of the contract indicated by the information indicating the true contractor and/or
(2) a true mortgagor of the revolving mortgage indicated by the information indicating the true mortgagor
to the user in response to rewriting of the true owner of the real estate indicated by the information indicating the true owner to the user by the rewriting means.

(Item 3)

The system of any one of the preceding items, wherein
information on tax payment of the real estate is stored in the storage means while being associated with the real estate, the information on the tax payment including information indicating a true taxpayer of the real estate, and
the second rewriting means automatically rewrites the true taxpayer of the real estate indicated by the information indicating the true taxpayer to the user in response to rewriting of the true owner of the real estate indicated by the information indicating the true owner to the user by the rewriting means.

(Item 4)

The system of any one of the preceding items, wherein the receiving means further receives personal information of the user, the system further comprises:
determining means for determining a real estate purchasing capability of the user based on the received personal information; and
judging means for judging whether or not the user can purchase the real estate from the determined real estate purchasing capability, and
the rewriting means rewrites the true owner of the real estate indicated by the information indicating the true owner to the user after it is judged that the user can purchase the real estate.

(Item 5)

The system of any one of the preceding items, wherein the storage means is configured to store information in an unalterable manner.

(Item 6)

A method for supporting purchase and sale of real estate, wherein
information indicating real estate on sale is stored in storage means, the storage means storing, while associating, information indicating a true owner of the real estate, information indicating a contract signed for the real estate, and information indicating a revolving mortgage on the real state, and
the method comprises:
receiving a request to purchase the real estate from a user;
rewriting the true owner of the real estate indicated by the information indicating the true owner to the user without changing real estate registration of the real estate, without changing the contract, and without changing a mortgagor of the revolving mortgage; and
notifying the user that purchase of the real estate has been completed.

(Item 6A)

The method of item 6, comprising the feature of one or more of the preceding items.

(Item 7)

A program for supporting purchase and sale of real estate, wherein the program is executed in a computer system comprising a processor unit and storage means,
information indicating real estate on sale is stored in the storage means, the storage means storing, while associating, information indicating a true owner of the real estate, information indicating a contract signed for the real estate, and information indicating a revolving mortgage on the real state, and
the program causes the processor unit to perform processing comprising:
receiving a request to purchase the real estate from a user;
rewriting the true owner of the real estate indicated by the information indicating the true owner to the user without changing real estate registration of the real estate, without changing the contract, and without changing a mortgagor of the revolving mortgage; and
notifying the user that purchase of the real estate has been completed.

(Item 7A)

The program of item 7, comprising the feature of one or more of the preceding items.

### Advantageous Effects of Invention

The present invention can enable real estate to be more easily purchased and sold by providing a system or the like for supporting purchase and sale of real estate, which can thereby lower the hurdle in purchase and sale of real estate, particularly investment in real estate, and activate the market of investment in real estate. This can also lead to improvement in the speed of distribution of real estate.

### BRIEF DESCRIPTION OF THE DRAWINGS

FIG. 1 is a diagram showing one example of a process in the service of the present invention.

FIG. 2 is a diagram showing one example of a configuration of a system 100 for supporting purchase and sale of real estate.

FIG. 3 is a diagram showing one example of a specific configuration of the system 100 for supporting purchase and sale of real estate.

FIG. 4 is a diagram showing one example of a data structure of real estate information stored in a blockchain network 200.

FIG. 5A is a diagram showing one example of a configuration of a processor unit 120.

FIG. 5B is a diagram showing one example of a configuration of a processor unit 120′, which is an alternative embodiment of the processor unit 120.

FIG. 6 is a flowchart showing one example of processing (processing 600) in the system 100 for supporting purchase and sale of real estate.

FIG. 7 is a diagram showing one example of a conventional process of purchase and sale of real estate.

### DETAILED DESCRIPTION

The embodiments of the present inventions are explained hereinafter while referring to the drawings.

1. New Service for Purchase and Sale of Real Estate

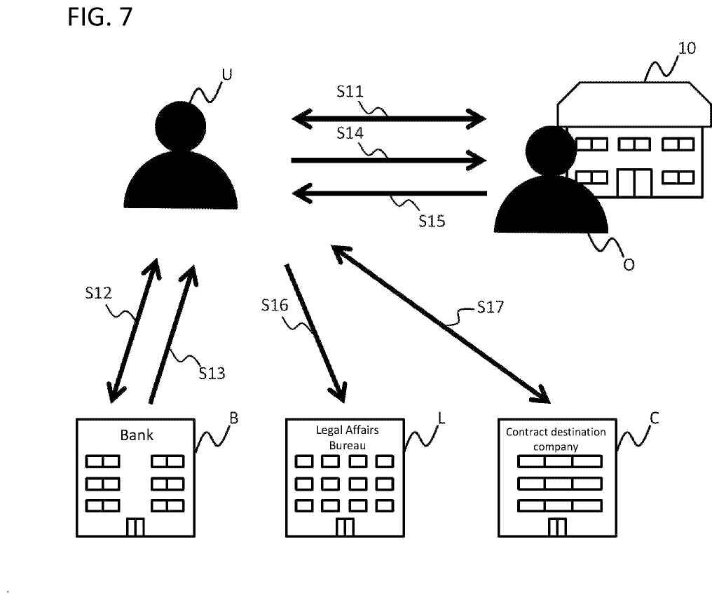

FIG. 7 shows one example of a conventional process of purchase and sale of real estate. This example explains a process for a user U to purchase real estate 10 from an owner O of the real estate 10.

It is assumed that the user U searched for real estate that said user wished to purchase, compared and considered the real estate, and decided to purchase the real estate 10.

In step S11, a sales contract for the real estate 10 is signed between the user U and the owner O. However, the user U does not have a sufficient fund for purchasing the real estate 10. Thus, the user U would get financing from a bank B through getting a loan.

In step S12, a monetary loan contract and a mortgage establishment contract are signed between the user U and the bank B. Before signing the contracts, the bank B can examine whether the user U has debt payment capability. After said user is determined to have sufficient debt payment capability, the bank B would sign the contracts.

Through the monetary loan contract, the user U would be financed with a fund for purchasing the real estate 10 by the bank B, and the user U would be obligated to return the fund. Through the mortgage establishment contract, a mortgage would be established on the real estate 10. The bank B becomes a lender in the mortgage while the user U becomes a borrower in the mortgage.

In step S13, financing of the fund from the bank B to the user U is executed under the monetary loan contract.

In step S14, the user U pays for the purchase of the real estate 10 to the owner O. The user U can utilize the fund through the financing received in step S13.

In step S15, the owner O hands over the real estate 10 to the user U, whereby the ownership of the real estate 10 is transferred from the owner O to the user U.

In association with the transfer of the ownership of the real estate 10, the user U performs real estate registration before Legal Affairs Bureau L in step S16. Through the real estate registration, it would be publicly notified that the owner of the real estate 10 is the user U.

In doing so, establishment of the mortgage is also registered in the real estate registration of the real estate 10 based on the mortgage establishment contract signed between the user U and the bank B. For the real estate registration of the real estate 10, the mortgage is registered, with the bank B as a lender in the mortgage and the user U as a borrower in the mortgage.

Furthermore, the user U can sign a contract on the real estate 10 with a contract destination company C. The contract can be, for example, a management entrustment contract and/or an insurance contract.

For example, it is possible to rent the real estate 10 for dwelling purposes of others, not for dwelling purposes of the user itself. Thus, the user U signs a contract with a management company as a contract destination company C and entrusts management of the real estate 10 to the management company. In step S17, a management entrustment contract on the real estate 10 is signed between the user U and the management company as a contract destination company C. Through the management entrustment contract, the management company would maintain and manage the real estate 10.

For example, the user U needs to have fire insurance for the real estate 10. Thus, the user U would sign an insurance contract with an insurance company as a contract destination company C. In step S17, a fire insurance contract on the real estate 10 is signed between the user U and the insurance company as a contract destination company C. Through the fire insurance contract, the insurance company would make a compensation upon a fire in the real estate 10.

As described above, when purchasing the real estate 10 from the owner O, the user U needs to:
(1) communicate with the bank B to get financing for a fund;
(2) perform real estate registration before Legal Affairs Bureau L and also register a mortgage;
(3) communicate with the management company as a contract destination company C to sign a management entrustment contract; and
(4) communicate with the insurance company as a contract destination company C to sign an insurance contract.

In the flow of conventional purchase and sale of real estate described above, the user U needs to communicate with many entities. Conventional purchase and sale of real estate used to be troublesome and time-consuming. The inventors of the present invention have renewed this flow and developed new service for purchase and sale of real estate. This service stores information on transfer of the ownership of real estate on a blockchain to eliminate the need for the user U to communicate with the bank B, Legal Affairs Bureau L, and the contract destination company C (management company and insurance company). This service enables real estate to be simply and immediately purchased and sold, which thereby lowers the hurdle in purchase and sale of real estate and promotes smooth distribution of real estate. This also leads to activation of the market of investment in real estate.

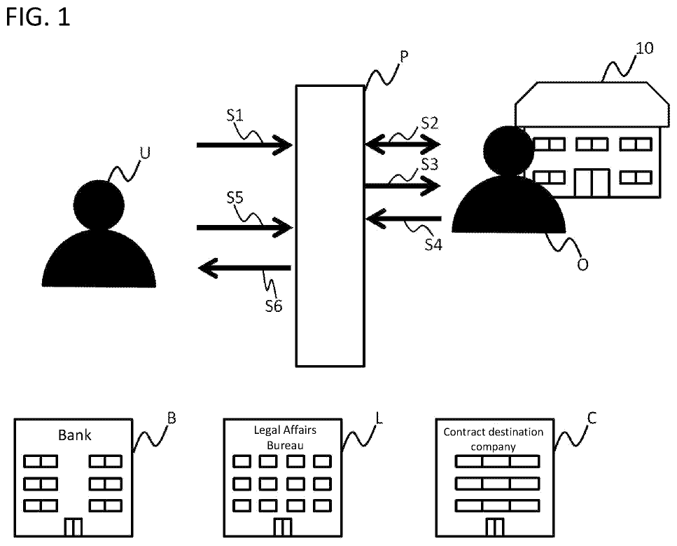

FIG. 1 shows one example of a process in the service of the present invention. This example explains a process for the user U to purchase the real estate 10 owned by the owner O via a service provider P of the service of the present invention.

First, in step S1, the user U registers utilization of the service of the present invention. The user U can register utilization via a terminal device (e.g., smartphone, tablet, personal computer or the like). The user U gives its personal information to the service provider P when registering utilization.

Examples of the personal information include, but are not limited to, age, annual income, workplace, length of continuous employment, family members, owned real estate, financial assets, debt balance, email address, bank account number, driver's license number, and My Number Card number.

The service provider P can examine a real estate purchasing capability of the user in advance based on the given personal information. For example, the service provider P can determine a financing condition such as maximum financeable amount as the real estate purchasing capability based on the given personal information. By examining the real estate purchasing capability of the user in advance, the service provider P can immediately sell real estate to the user U in response to a request to purchase real estate from the user U as described below.

Meanwhile, the service provider P purchases the real estate 10 from the owner O. In step S2, a sales contract for the real estate 10 is signed between the service provider P and the owner O. The service provider P pays for the purchase of the real estate 10 to the owner O based on the contract in step S3. In step S4, the owner O hands over the real estate 10 to the service provider P, whereby the ownership of the real estate 10 is transferred from the owner O to the service provider P.

The service provider P performs real estate registration of the real estate 10 before Legal Affairs Bureau L. Through the real estate registration, it would be publicly notified that the owner of the real estate 10 is the service provider P.

The service provider P signs a revolving mortgage establishment contract on the real estate 10 with the bank B. The bank B is a mortgagee while the service provider P is a mortgagor. Establishment of the revolving mortgage can also be registered in real estate registration of the real estate 10. For the real estate registration of the real estate 10, the mortgage is registered, with the bank B as a mortgagee and the service provider P as a mortgagor. Through the establishment of the revolving mortgage, the service provider P can get financing from the bank B within the established maximum amount.

The service provider P signs a management entrustment contract on the real estate 10 with a management company as a contract destination company C. Through the management entrustment contract, the management company M will maintain and manage the real estate 10.

The service provider P signs an insurance contract on the real estate 10 with an insurance company as a contract destination company C. For example, a fire insurance contract covering the real estate 10 is signed.

The service provider P stores information on the real estate 10 on a blockchain as an NFT (Non Fungible Token). Information indicating a true owner of the real estate 10, information indicating a true mortgagor of the real estate 10, and information indicating a true contractor of the contract on the real estate 10 would be stored in the NFT of the real estate 10. The NFT of the real estate 10 may be configured to also store information indicating a true taxpayer of the real estate 10.

When the ownership of the real estate 10 is transferred from the owner O to the service provider P, the service provider P generates an NFT for storing information on the real estate 10 on a blockchain and writes that the true owner of the real estate 10 is the service provider P. By configuring the blockchain to be of a public type, it is possible to impart the same level of public notification power as conventional real estate registration to the information stored on the blockchain. In addition, since it is substantially impossible to alter the information stored in the blockchain, the reliability of the information stored on the blockchain can also be secured. The reliability of the information can be further enhanced by limiting the entity capable of rewriting the information stored on the blockchain (e.g., limiting the entity to only the service provider P). The inventors of the present invention have found that storing real estate information on a blockchain eliminates the need for conventional real estate registration.

The NFT of the real estate 10 stores that the true owner of the real estate 10 is the service provider P. Accordingly, said NFT also stores that each of the true mortgagor of the real estate 10, the true contractor of the contract on the real estate 10, and the true taxpayer of the real estate 10 is the service provider P.

The service provider P can purchase real estate not only from the owner O but also from other real estate owners. The service provider P can generate and store an NFT on a blockchain for each real estate.

It is assumed that the user U searched for real estate that said user wished to purchase from real estate of which purchase and sale are supported by the service provider P, compared and considered the real estate, and decided to purchase the real estate 10.

In step S5, the user U transmits a request to purchase the real estate 10 to the service provider P. The user U can transmit the request to the service provider P via a terminal device (e.g., smartphone, tablet, personal computer or the like).

When the service provider P receives the request to purchase the real estate 10, the service provider P judges whether the user U is capable of purchasing the real estate 10. For example, it is possible to judge whether the user U is capable of purchasing the real estate 10 based on the real estate purchasing capability of the user U that was examined in advance. For example, it would be judged whether or not said user can purchase the real estate 10 based on the financing under the financing condition that was determined through the examination in advance.

When it is judged that the user U is capable of purchasing the real estate 10, the service provider P would sell the real estate 10 to the user U. The service provider P rewrites the true owner stored in the NFT of the real estate 10 from the service provider P to the user U, whereby the ownership of the real estate 10 is transferred from the service provider P to the user U, and the sale of the real estate 10 is completed. When the true owner stored in the NFT is rewritten to the user U, each of the true mortgagor of the real estate 10, the true contractor of the contract on the real estate 10, and the true taxpayer of the real estate 10 stored in the NFT can also be rewritten to the user U.

In doing so, the user U does not need to perform real estate registration of the real estate 10 because the NFT on the blockchain ensures that the true owner of the real estate 10 is the user U although the owner of the real estate 10 registered before Legal Affairs Bureau L remains the service provider P. Furthermore, the user U does not need to change the mortgagor of the real estate 10 or change the contract on the real estate 10 because the NFT on the blockchain ensures that the true mortgagor of the real estate 10 is the user U although the mortgagor in the contract with the bank B or the registration before Legal Affairs Bureau L remains the service provider P, and the NFT on the blockchain ensures that the true contractor of the contract on the real estate 10 is the user U although the contractor in the contract on the real estate 10 remains the service provider P.

When the sale of the real estate 10 to the user U is completed, a notice that the real estate 10 has been sold is transmitted to the user U in step S6. The user U can receive the notice from the service provider P via a terminal device (e.g., smartphone, tablet, personal computer or the like). Through the notice, the user U can know that the real estate 10 belongs to said user.

As described above, when purchasing the real estate 10 from the owner O, the user U does not need to:
(1) communicate with the bank B to get financing for a fund;
(2) perform real estate registration before Legal Affairs Bureau L and also register a mortgage;
(3) communicate with the management company as a contract destination company C to sign a management entrustment contract; or
(4) communicate with the insurance company as a contract destination company C to sign an insurance contract. Rather, the user U can purchase the real estate 10 only by registering to become a member and transmitting a request to purchase the real estate 10. The user U can thereby simply and immediately purchase the real estate. The user U can timely purchase real estate, which is especially useful for purchasing real estate for investment.

The service described above can be implemented by a system for supporting purchase and sale of real estate which will be described below.

2. Configuration of a System for Supporting Purchase and Sale of Real Estate

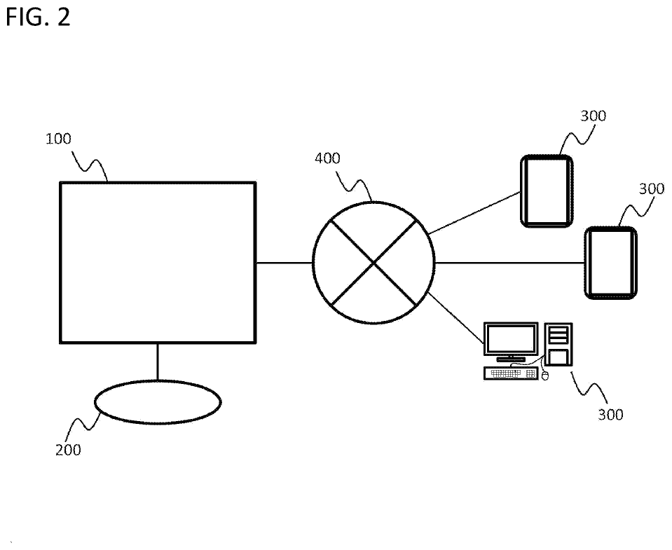

FIG. 2 shows one example of a configuration of a system 100 for supporting purchase and sale of real estate.

The system 100 is connected to a blockchain network 200. The system 100 is also connected to at least one terminal device 300 via a network 400.

Although FIG. 2A shows three terminal devices 300, the number of terminal devices 300 is not limited thereto. Any number of terminal devices 300 can be connected to the system 100 via the network 400.

The network 400 can be any type of network. For example, the network 400 may be the Internet or may be LAN. The network 400 may be a wired network or may be a wireless network.

The blockchain network 200 is a network constructed by a blockchain technique, which can be utilized to manage real estate information. Since alteration of the managed information can be easily detected by using a blockchain technique, it is substantially impossible to alter the real estate information managed by the blockchain network 200, which secures the reliability of the real estate information managed by the blockchain network 200.

Although it was explained that the real estate information would be managed by a blockchain technique, the present invention is not limited to those using a blockchain technique. Any technique can be utilized to construct the blockchain network 200 as long as real estate information can be managed in a substantially unalterable manner.

By configuring the blockchain network 200 to be a public network, it is possible to impart the same level of public notification power as conventional real estate registration to the information managed by the blockchain network 200. In addition, since it is substantially impossible to alter the information stored in the blockchain network 200, the reliability of the information stored on the blockchain network 200 can also be secured. The reliability of the information can be further enhanced by limiting the entity capable of rewriting the information stored on the blockchain network 200 (e.g., limiting the entity to only the system 100). The inventors of the present invention consider that managing real estate information in the blockchain network 200 eliminates the need for conventional real estate registration.

One example of the system 100 is, but not limited to, a computer (e.g., server device) installed in a service provider (e.g., service provider P in FIG. 1) that provides a platform of purchase and sale of real estate. One example of the terminal device 300 is, but not limited to, a computer (e.g., terminal device) utilized by a user selling real estate or a user purchasing real estate. In this regard, the computer (server device or terminal device) can be any type of computer. For example, the terminal device can be any type of terminal device such as smartphones, tablets, personal computers, smart glasses, or smart watches.

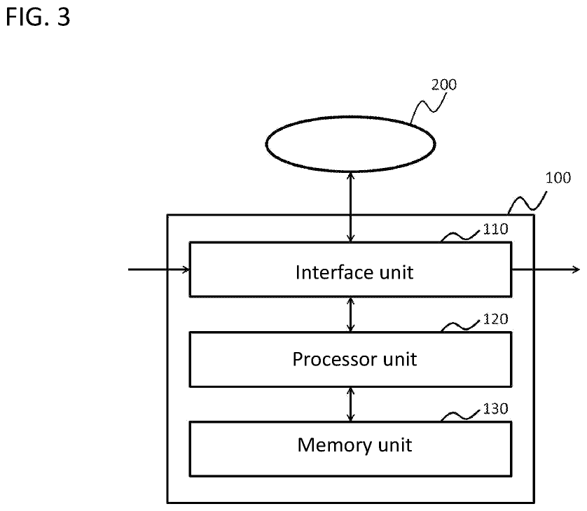

FIG. 3 shows one example of a specific configuration of the system 100 for supporting purchase and sale of real estate.

The system 100 comprises an interface unit 110, a processor unit 120, and a memory unit 130.

The interface unit 110 exchanges information with an element that is external to the system 100. The processor unit 120 of the system 100 can receive information from an element that is external to the system 100 via the interface unit 110 and transmit information to an element that is external to the system 100. The interface unit 110 can exchange information in any form.

The interface unit 110 comprises, for example, an input unit that enables input of information into the system 100. The input unit can enable input of information into the system 100 in any mode. For example, if the input unit is a receiver, the input unit can be configured so that the receiver receives information as an input from an element that is external to the system 100 via a network. Alternatively, if the input unit is a data reader, the input unit can be configured so that information is inputted by reading information from a storage medium connected to the system 100.

The interface unit 110 comprises, for example, an output unit that enables output of information from the system 100. The output unit can enable output of information from the system 100 in any mode. For example, if the output unit is a transmitter, the transmitter can output information by transmitting the information to an element that is external to the system 100 via a network. Alternatively, if the output unit is a data writer, the output unit can be configured so that information is outputted by writing information on a storage medium connected to the system 100.

For example, the system 100 can transmit information to the blockchain network 200 and/or receive information from the blockchain network 200 via the interface unit 110. For example, the system 100 can transmit information to the terminal device 300 and/or receive information from the terminal device 300 via the interface unit 110.

For example, the system 100 can receive a request to purchase real estate from the terminal device 300 of a user via the interface unit 110. For example, the system 100 can transmit an instruction to rewrite information stored in the blockchain network 200 via the interface unit 110. For example, the system 100 can transmit a notice that purchase of real estate has been completed to the terminal device 300 of a user via the interface unit 110.

The processor unit 120 executes processing of the system 100 and controls operation of the entire system 100. The processor unit 120 reads out a program stored in the memory unit 130 and executes the program, whereby the system 100 can be caused to function as a system for executing a desired step. The processor unit 120 may be implemented by a single processor or may be implemented by a plurality of processors.

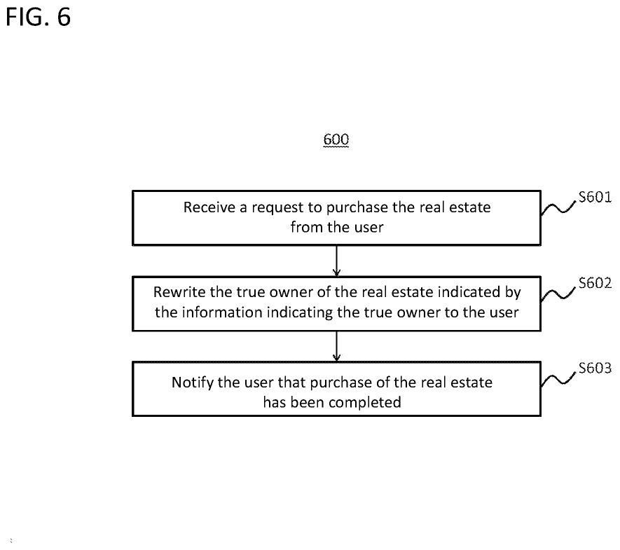

The memory unit 130 stores a program required for executing processing of the system 100, data required for executing the program, and the like. The memory unit 130 may also store a program for causing the processor unit 120 to perform processing for supporting purchase and sale of real estate (e.g., a program that materializes the processing shown in FIG. 6 described below). In this regard, a program can be stored in the memory unit 130 in any manner. For example, a program may be preinstalled in the memory unit 130. Alternatively, a program may be installed in the memory unit 130 by downloading via a network. In such a case, the network can be any type of network. The memory unit 130 can be implemented by any storage means. Alternatively, a program may be stored in a non-transitory computer-readable storage medium and installed in the memory unit 130 by reading the storage medium.

For example, information on real estate on sale can be stored in the blockchain network 200.

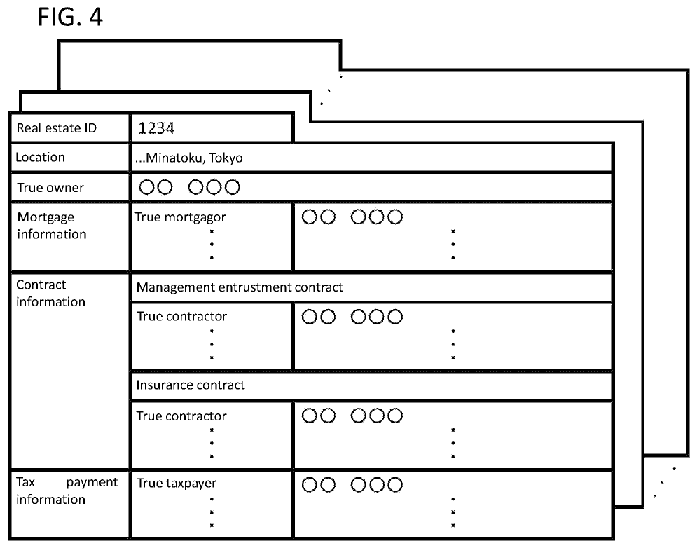

FIG. 4 shows one example of a data structure of real estate information stored in the blockchain network 200.

For example, the blockchain network 200 can store one real estate as one NFT. The NFT of each real estate stores, while associating, real estate ID and real estate information on the real estate. The real estate information can include information indicating a location of the real estate, information indicating a true owner of the real estate, information indicating a mortgage on the real estate, and information indicating a contract signed for the real estate. The real estate information can also include information on tax payment of the real estate.

The information indicating the mortgage can include information indicating a revolving mortgage on the real estate. The information indicating the revolving mortgage includes at least information indicating a true mortgagor. The information indicating the revolving mortgage can also include, for example, information indicating a mortgagee of the revolving mortgage, information on establishment of the revolving mortgage (e.g., amount of establishment, date of establishment, or the like).

The information indicating the contract signed for the real estate can include information indicating a management entrustment contract on the real estate and information indicating an insurance contract covering the real estate. The information indicating the management entrustment contract includes at least information indicating a true contractor of the management entrustment contract. The information indicating the management entrustment contract can also include, for example, information indicating a manager and content of the management entrustment contract (e.g., content of the management or the like). The information indicating the insurance contract includes at least information indicating a true contractor of the insurance contract. The information indicating the insurance contract can also include information indicating an insurance company and content of the insurance contract (e.g., content of compensation or the like).

The information on the tax payment includes information on payment of tax on the real estate (e.g., property tax) and includes at least information indicating a true taxpayer. The information on the tax payment can also include, for example, content of tax payment (e.g., amount of tax paid, date of tax payment, or the like).

The information stored in the blockchain network 200 can be rewritten by the system 100. The system 100 can at least rewrite the true owner indicated by the information indicating the true owner. Furthermore, in addition to the true owner, the system 100 can rewrite the true contractor indicted by the information indicating the true contractor and the true mortgagor indicated by the information indicating the true mortgagor. Furthermore, in addition to them, the system 100 can also rewrite the true taxpayer indicated by the information indicating the true taxpayer. Alternatively, the system 100 may be configured so that the true contractor, the true mortgagor, and the true taxpayer are automatically rewritten in response to rewriting of the true owner by the system 100.

In the example shown in FIGS. 2 and 3, the blockchain network 200 is provided externally to the system 100, but the present invention is not limited thereto. It is also possible to provide at least a part of the blockchain network 200 inside the system 100. At least a part of the blockchain network 200 is configured as storage means for the system 100. Typically, the configuration of the blockchain network 200 is, but not limited to, a distributed network utilizing a blockchain technique or the like.

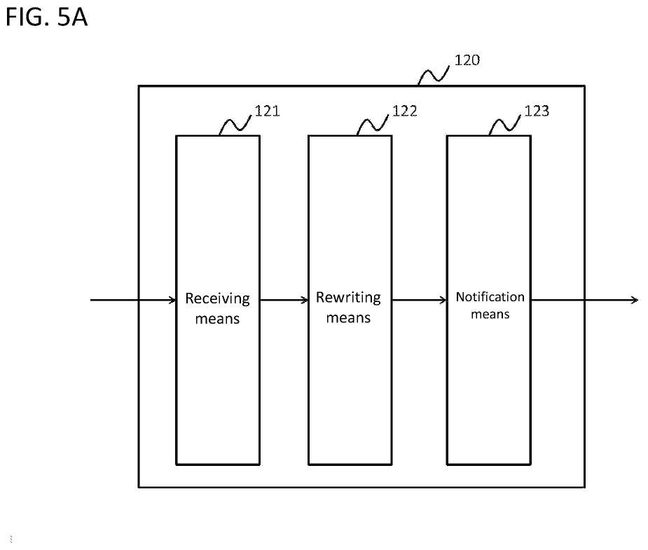

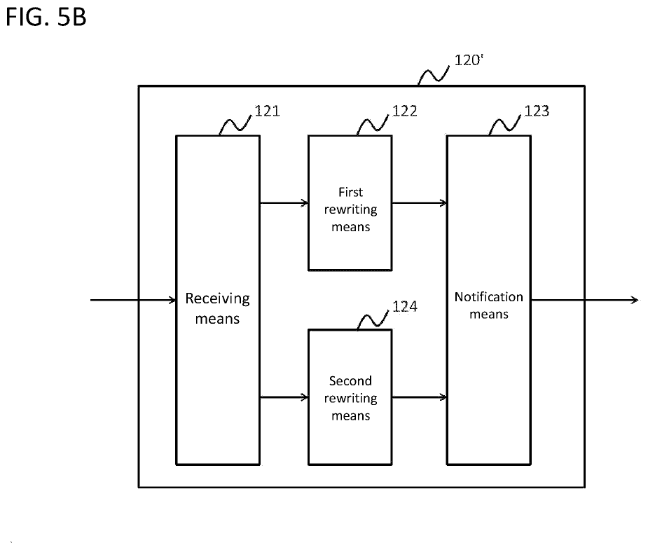

FIG. 5A shows one example of a configuration of a processor unit 120.

The processor unit 120 comprises receiving means 121, rewriting means 122, and notification means 123.

The receiving means 121 is configured to receive a request to purchase real estate from a user. For example, the receiving means 121 can receive a request from the terminal device 300 of the user via the interface unit 110.

The receiving means 121 can further receive personal information of the user. For example, the receiving means 121 can receive personal information from the terminal device 300 of the user via the interface unit 110. Alternatively, for example, the receiving means 121 can receive personal information from an appropriate place of the network 400 via the interface unit 110. The received personal information can be stored in a database unit (not shown) to which the processor unit 120 is connected. At least a part of the database unit may be a part of the system 100 or may be a component that is external to the system 100. The configuration of the database unit is not limited to a specific hardware configuration. For example, the database unit may be configured as a single hardware part or configured as a plurality of hardware parts. For example, the database unit may be configured as an external hard disk device of the system 100, configured as a storage on the cloud connected via a network, or configured as a distributed network utilizing a blockchain technique or the like. At least a part of the database unit may also be configured by the blockchain network 200.

The received request is given to the rewriting means 122.

Alternatively, the processor unit 120 may be configured to judge whether or not the user can purchase real estate that the user requests to purchase based on the received request, and give the request to the rewriting means 122 when it is judged that the user can purchase the real estate. In doing so, the processor unit 120 can comprise: determining means for determining a real estate purchasing capability of the user based on the personal information (e.g., age, annual income, workplace, length of continuous employment, family members, owned real estate, financial assets, debt balance, or the like) of the user that can be stored in a database unit (not shown); and judging means for judging whether or not the user can purchase the real estate from the determined real estate purchasing capability. For example, the real estate purchasing capability can indicate the scope of real estate that can be purchased with assets currently owned by the user, or can indicate the scope of real estate that can be purchased with financing under a financing condition such as maximum financeable amount which is determined based on the personal information of the user. The judging means can judge, for example, whether or not the real estate that the user requests to purchase is within the scope of real estate indicated by the real estate purchasing capability.

The rewriting means 122 is configured to rewrite a true owner of real estate indicated by information indicating a true owner stored in the blockchain network 200 (storage means) to the user. The rewriting means 122 can rewrite the true owner of the real estate to the user without changing real estate registration of the real estate, without changing a contract signed for the real estate, and without changing a mortgagor of a revolving mortgage on the real estate. The rewriting means 122 does not perform processing of changing the real estate registration of the real estate and does not need to perform processing of changing the real estate registration of the real estate externally to the system 100. The rewriting means 122 does not perform processing of changing the contract signed for the real estate and does not need to perform processing of changing the contract signed for the real estate externally to the system 100. The rewriting means 122 does not perform processing of changing the mortgagor of the revolving mortgage on the real estate and does not need to perform processing of changing the mortgagor of the revolving mortgage on the real estate externally to the system 100.

The rewriting means 122 can access the blockchain network 200 via the interface unit 110 to rewrite information stored in the blockchain network 200. For example, the rewriting means 122 may be configured to rewrite by overwriting the user on the true owner of the real estate stored in the blockchain network 200. Alternatively, for example, the rewriting means 122 may be configured to rewrite by additionally writing that the latest true owner of the real estate stored in the blockchain network 200 is the user.

By rewriting the true owner of the real estate stored in the blockchain network 200 to the user, it would be publicly notified that the true owner of the real estate is the user. Further, since the blockchain network 200 is configured so that alteration is substantially impossible, the reliability of the true owner of the real estate being the user would be also ensured. Even if the owner on real estate registration is inconsistent with the true owner which is stored in the blockchain network 200, those who perform real estate transaction can perform transaction while believing that the true owner of the real estate is the user based on the public notification property and reliability of the blockchain network 200.

The notification means 123 is configured to notify the user that purchase of the real estate has been completed. For example, the notification means 123 can transmit a notification to the terminal device 300 of the user via the interface unit 110, whereby the user can know that purchase of the real estate has been completed.

FIG. 5B shows one example of a configuration of a processor unit 120′, which is an alternative embodiment of the processor unit 120.

The processor unit 120′ has the same configuration as that of the processor unit 120, except for comprising second rewriting means 124. In FIG. 5B, referring to FIG. 5A, the same reference number is given to the same component as the above-described configuration and a detailed explanation is omitted herein.

The processor unit 120 comprises receiving means 121, first rewriting means 122, second rewriting means 124, and notification means 123. The first rewriting means 122 is identical to the rewriting means 122 described above while referring to FIG. 5A.

The second rewriting means 124 is configured to automatically rewrite a true contractor indicated by information indicating a true contractor and/or a true mortgagor indicated by information indicating a true mortgagor stored in the blockchain network 200 (storage means) to a user in response to rewriting of a true owner of real estate to the user by the first rewriting means 122.

The second rewriting means 124 can access the blockchain network 200 via the interface unit 110 to rewrite information stored in the blockchain network 200. For example, the second rewriting means 124 may be configured to rewrite by overwriting the user on the true contractor and the true mortgagor of the real estate stored in the blockchain network 200. Alternatively, for example, the second rewriting means 124 may be configured to rewrite by additionally writing that the latest true contractor and true mortgagor of the real estate stored in the blockchain network 200 are the user.

For example, in response to rewriting of the true owner of the real estate to the user by the first rewriting means 122, the second rewriting means 124 accesses the blockchain network 200 and judges whether or not information indicating a true contractor and/or information indicating a true mortgagor are stored for the real estate of which true owner has been rewritten by the first rewriting means 122. When the information indicating the true contractor and/or information indicating the true mortgagor are stored in the blockchain network 200, the second rewriting means 124 can automatically rewrite the true contractor indicated by the information indicating the true contractor and/or the true mortgagor indicated by the information indicating the true mortgagor to the user.

In doing so, the second rewriting means 124 can also automatically rewrite the true contractor and/or the true mortgagor of the real estate to the user without changing real estate registration of the real estate, without changing a contract signed for the real estate, and without changing a mortgagor of a revolving mortgage on the real estate. The second rewriting means 124 does not perform processing of changing the real estate registration of the real estate and does not need to perform processing of changing the real estate registration of the real estate externally to the system 100. The second rewriting means 124 does not perform processing of changing the contract signed for the real estate and does not need to perform processing of changing the contract signed for the real estate externally to the system 100. The second rewriting means 124 does not perform processing of changing the mortgagor of the revolving mortgage on the real estate and does not need to perform processing of changing the mortgagor of the revolving mortgage on the real estate externally to the system 100.

By rewriting the true contractor and/or the true mortgagor of the real estate stored in the blockchain network 200 to the user, it would be publicly notified that the true contractor and/or the true mortgagor of the real estate is the user. Further, since the blockchain network 200 is configured so that alteration is substantially impossible, the reliability of the true contractor and/or the true mortgagor of the real estate being the user would be also ensured. Even if the contractor on a contract is inconsistent with the true contractor stored in the blockchain network 200, and/or even if the mortgagor which is registered is inconsistent with the true mortgagor which is stored in the blockchain network 200, the other party of the contract and/or the lender in the mortgage can fulfill the content of the contract and/or exercise the right while believing that the true contractor and/or the true mortgagor of the real estate is the user based on the public notification property and reliability of the blockchain network 200.

In response to rewriting of the true owner of the real estate to the user by the first rewriting means 122, the second rewriting means 124 can further automatically rewrite a true taxpayer indicated by information indicating a true taxpayer which is stored in the blockchain network 200 (storage means) to the user.

For example, the second rewriting means 124 may be configured to access the blockchain network 200 via the interface unit 110 and rewrite by overwriting the user on the true taxpayer of the real estate stored in the blockchain network 200. Alternatively, for example, the second rewriting means 124 may be configured to access the blockchain network 200 via the interface unit 110 and rewrite by additionally writing that the latest true taxpayer of the real estate stored in the blockchain network 200 is the user.

For example, in response to rewriting of the true owner of the real estate to the user by the first rewriting means 122, the second rewriting means 124 accesses the blockchain network 200 and judges whether or not information indicating a true taxpayer is stored for the real estate of which true owner has been rewritten by the first rewriting means 122. When the information indicating the true taxpayer is stored in the blockchain network 200, the second rewriting means 124 can automatically rewrite the true taxpayer indicated by the information indicating the true taxpayer to the user.

In doing so, the second rewriting means 124 can also automatically rewrite the true taxpayer of the real estate to the user without changing real estate registration of the real estate, without changing a contract signed for the real estate, and without changing a mortgagor of a revolving mortgage on the real estate. The second rewriting means 124 does not perform processing of changing the real estate registration of the real estate and does not need to perform processing of changing the real estate registration of the real estate externally to the system 100. The second rewriting means 124 does not perform processing of changing the contract signed for the real estate and does not need to perform processing of changing the contract signed for the real estate externally to the system 100. The second rewriting means 124 does not perform processing of changing the mortgagor of the revolving mortgage on the real estate and does not need to perform processing of changing the mortgagor of the revolving mortgage on the real estate externally to the system 100.

By rewriting the true taxpayer of the real estate stored in the blockchain network 200 to the user, it would be publicly notified that the true taxpayer of the real estate is the user. Further, since the blockchain network 200 is configured so that alteration is substantially impossible, the reliability of the true taxpayer of the real estate being the user would be also ensured. Even if the owner which is registered is inconsistent with the true taxpayer which is stored in the blockchain network 200, the Tax Office can collect taxes while believing that the true taxpayer of the real estate is the user based on the public notification property and reliability of the blockchain network 200.

Although each component of the processor unit 120 or 120′ is provided in the same processor unit 120 or 120′ in the above-described examples shown in FIGS. 5A and 5B, the present invention is not limited thereto. A configuration wherein each component of the processor unit 120 or 120′ is dispersed in a plurality of processor units also remains within the scope of the present invention. In this case, the plurality of processor units may be located in the same hardware part or located in separate hardware parts that are close to each other or remote from each other.

Furthermore, each component of the above-described system 100 may be configured as a single hardware part or configured as a plurality of hardware parts. When each component is configured as a plurality of hardware parts, the hardware parts are connected in any mode. The hardware parts may be wirelessly connected or connected by wire. The system 100 of the present invention is not limited to a specific hardware configuration. A configuration wherein the processor unit 120 or 120′ is configured with an analog circuit instead of a digital circuit also remains within the scope of the present invention. The configuration of the system 100 of the present invention is not limited to those described above as long as the function of said system can be materialized.

3. Processing in a System for Supporting Purchase and Sale of Real Estate

FIG. 6 shows one example of processing (processing 600) in the system 100 for supporting purchase and sale of real estate. The processing 600 is performed in the processor unit 120 of the system 100. The processing 600 can also be performed in the same manner in the processor unit 120′.

The processor unit 120 can communicate with storage means (blockchain network 200) via the interface unit 110. As described above, the blockchain network 200 stores information on real estate on sale, and the blockchain network 200 stores, while associating, at least information indicating a true owner of the real estate, information indicating a contract signed for the real estate, and information indicating a revolving mortgage on the real estate. In addition to them, the blockchain network 200 can also store, while associating with the real estate, information on tax payment of the real estate. The information indicating the contract can include information indicating a true contractor of the contract, and the information indicating the revolving mortgage can include information indicating a true mortgagor of the revolving mortgage. The information on the tax payment can include information indicating a true taxpayer of the real estate.

The receiving means 121 of the processor unit 120 can receive personal information of a user in advance. The receiving means 121 can store the received personal information in a database unit.

In step S601, the receiving means 121 of the processor unit 120 receives a request to purchase the real estate from the user. For example, the receiving means 121 can receive the request from the terminal device 300 of the user via the interface unit 110.

The receiving means 121 can give the received request to the writing means 122. Alternatively, said receiving means may be configured so that the determining means of the processor unit 120 determines a real estate purchasing capability of the user based on the personal information of the user, the judging means of the processor unit 120 judges whether or not the user can purchase the real estate from the determined real estate purchasing capability, and when it is judged that the user can purchase the real estate, the receiving means gives the request to the rewriting means 122.

In step S602, the rewriting means 122 of the processor unit 120 rewrites the true owner of the real estate indicated by the information indicating the true owner stored in the storage means to the user. The rewriting means 122 rewrites the true owner of the real estate to the user without changing real estate registration of the real estate, without changing the contract signed for the real estate, and without changing the mortgagor of the revolving mortgage on the real estate.

The rewriting means 122 can access the storage means to rewrite information stored in the storage means. For example, the rewriting means 122 may be configured to rewrite by overwriting the user on the true owner of the real estate stored in the storage means. Alternatively, for example, the rewriting means 122 may be configured to rewrite by additionally writing that the latest true owner of the real estate stored in the storage means is the user.

By making the storage public and rewriting the true owner of the real estate stored in the storage means to the user, it would be publicly notified that the true owner of the real estate is the user. Further, by configuring the storage means so that alteration is substantially impossible, the reliability of the true owner of the real estate being the user would be also ensured. Even if the owner on real estate registration is inconsistent with the true owner which is stored in the storage means, those who perform real estate transaction can perform transaction while believing that the true owner of the real estate is the user based on the public notification property and reliability of the storage means.

In step S603, the notification means 123 of the processor unit 120 notifies the user that purchase of the real estate has been completed. For example, the notification means 123 can transmit a notification to the terminal device 300 of the user via the interface unit 110, whereby the user can know that purchase of the real estate has been completed.

In this manner, the user can purchase the real estate through the processing 600 without the need for carrying out a troublesome and time-consuming procedure. The user U can simply and immediately purchase the real estate, which is especially useful for purchasing real estate for investment.

When the processing 600 is performed in the processor unit 120′, an additional step can be provided after step S602 and before step S603. In the additional step, the second rewriting means 124 of the processor unit 120′ automatically rewrites the true contractor indicated by the information indicating the true contractor of the real estate and/or the true mortgagor indicated by the information indicating the true mortgagor to the user in response to rewriting of the information stored in the storage means by the first rewriting means 122 in step S602.

The second rewriting means 124 can access the storage means to rewrite information stored in the storage means. For example, the second rewriting means 124 may be configured to rewrite by overwriting the user on the true contractor and the true mortgagor of the real estate stored in the storage means. Alternatively, for example, the second rewriting means 124 may be configured to rewrite by additionally writing that the latest true contractor and true mortgagor of the real estate stored in the storage means are the user.

For example, in response to rewriting of the true owner of the real estate to the user by the first rewriting means 122 in step S602, the second rewriting means 124 accesses the storage means and judges whether or not information indicating a true contractor and/or information indicating a true mortgagor are stored for the real estate of which true owner has been rewritten by the first rewriting means 122. When the information indicating the true contractor and/or information indicating the true mortgagor are stored in the blockchain network 200, the second rewriting means 124 can automatically rewrite the true contractor indicated by the information indicating the true contractor and/or the true mortgagor indicated by the information indicating the true mortgagor to the user.

In doing so, the second rewriting means 124 can automatically rewrite the true contractor and/or the true mortgagor of the real estate to the user without changing real estate registration of the real estate, without changing the contract signed for the real estate, and without changing the mortgagor of the revolving mortgage on the real estate.

By making the storage means public and rewriting the true contractor and/or the true mortgagor of the real estate stored in the storage means to the user, it would be publicly notified that the true contractor and/or the true mortgagor of the real estate is the user. Further, by configuring the storage means so that alteration is substantially impossible, the reliability of the true contractor and/or the true mortgagor of the real estate being the user would be also ensured. Even if the contractor on a contract is inconsistent with the true contractor which is stored in the storage means, and/or even if the mortgagor which is registered is inconsistent with the true mortgagor which is stored in the storage means, the other party of the contract and/or the lender in the mortgage can fulfill the content of the contract and/or exercise the right while believing that the true contractor and/or the true mortgagor of the real estate is the user based on the public notification property and reliability of the storage means.

Furthermore, when rewriting the true contractor and/or the true mortgagor, the second rewriting means 124 can automatically rewrite the true taxpayer indicated by the information indicating the true taxpayer of the real estate to the user.

By making the storage means public and rewriting the true taxpayer of the real estate stored in the storage means to the user, it would be publicly notified that the true taxpayer of the real estate is the user. Further, by configuring the storage means so that alteration is substantially impossible, the reliability of the true taxpayer of the real estate being the user would be also ensured. Even if the owner which is registered is inconsistent with the true taxpayer which is stored in the storage means, the Tax Office can collect taxes while believing that the true taxpayer of the real estate is the user based on the public notification property and reliability of the storage means.

In this manner, purchase and sale of real estate can be smoothly performed even without changing the owner on real estate registration, the mortgagor which is registered, and the contractor on a contract, which can thereby lower the hurdle in purchase and sale of real estate and promote smooth distribution of real estate.

Although it was explained that the processing is performed in a specific order in the example described above while referring to FIG. 6, the order of each processing is not limited to the order explained. Each processing can be performed in any theoretically possible order.

Although it was explained that processing of each step shown in FIG. 6 is materialized by the processor unit 120 or 120′ and a program stored in the memory unit 130 in the example described above while referring to FIG. 6, the present invention is not limited thereto. At least one of the processing of each step shown in FIG. 6 may be materialized by a hardware configuration such as a control circuit.

The present invention is not limited to the embodiments described above. It is understood that the scope of the present invention should be interpreted solely from the scope of Claims. It is understood that those skilled in the art can implement an equivalent scope based on the description of the present invention and common general knowledge from the descriptions of the specific preferred embodiments of the present invention.

### INDUSTRIAL APPLICABILITY

The present invention is useful as an invention which provides a system or the like for supporting purchase and sale of real estate which can make purchase and sale of real estate easier.

### REFERENCE SIGNS LIST

U User
O Owner
P Service provider
10 Real estate
100 System
200 Blockchain network
300 Terminal device
400 Network

1. A system for supporting purchase and sale of real estate, comprising:
storage means for storing information indicating real estate on sale, the storage means storing, while associating, information indicating a true owner of the real estate, information indicating a contract signed for the real estate, and information indicating a revolving mortgage on the real state;
receiving means for receiving a request to purchase the real estate from a user;
rewriting means for rewriting the true owner of the real estate indicated by the information indicating the true owner to the user without changing real estate registration of the real estate, without changing the contract, and without changing a mortgagor of the revolving mortgage; and
notification means for notifying the user that purchase of the real estate has been completed.

2. The system of claim 1, wherein
the information indicating the contract includes information indicating a true contractor of the contract, and the information indicating the revolving mortgage includes information indicating a true mortgagor of the revolving mortgage, and
the system further comprises:
second rewriting system for automatically rewriting
(1) the true contractor of the contract indicated by the information indicating the true contractor and/or
(2) a true mortgagor of the revolving mortgage indicated by the information indicating the true mortgagor
to the user in response to rewriting of the true owner of the real estate indicated by the information indicating the true owner to the user by the rewriting means.

3. The system of claim 2, wherein
information on tax payment of the real estate is stored in the storage means while being associated with the real estate, the information on the tax payment including information indicating a true taxpayer of the real estate, and
the second rewriting means automatically rewrites the true taxpayer of the real estate indicated by the information indicating the true taxpayer to the user in response to rewriting of the true owner of the real estate indicated by the information indicating the true owner to the user by the rewriting means.

4. The system of claim 1, wherein
the receiving means further receives personal information of the user,
the system further comprises:
determining means for determining a real estate purchasing capability of the user based on the received personal information; and
judging means for judging whether or not the user can purchase the real estate from the determined real estate purchasing capability, and
the rewriting means rewrites the true owner of the real estate indicated by the information indicating the true owner to the user after it is judged that the user can purchase the real estate.

5. The system of claim 1, wherein the storage means is configured to store information in an unalterable manner.

6. The system of claim 2, wherein the storage means is configured to store information in an unalterable manner.

7. The system of claim 3, wherein the storage means is configured to store information in an unalterable manner.

8. The system of claim 4, wherein the storage means is configured to store information in an unalterable manner.

9. A method for supporting purchase and sale of real estate, wherein
information indicating real estate on sale is stored in storage means, the storage means storing, while associating, information indicating a true owner of the real estate, information indicating a contract signed for the real estate, and information indicating a revolving mortgage on the real state, and
the method comprises:
receiving a request to purchase the real estate from a user;
rewriting the true owner of the real estate indicated by the information indicating the true owner to the user without changing real estate registration of the real estate, without changing the contract, and without changing a mortgagor of the revolving mortgage; and
notifying the user that purchase of the real estate has been completed.

10. A non-transitory computer-readable storage medium storing a program for supporting purchase and sale of real estate, wherein
the program is executed in a computer system comprising a processor unit and storage means,
information indicating real estate on sale is stored in the storage means, the storage means storing, while associating, information indicating a true owner of the real estate, information indicating a contract signed for the real estate, and information indicating a revolving mortgage on the real state, and
the program causes the processor unit to perform processing comprising:
receiving a request to purchase the real estate from a user;
rewriting the true owner of the real estate indicated by the information indicating the true owner to the user without changing real estate registration of the real estate, without changing the contract, and without changing a mortgagor of the revolving mortgage; and
notifying the user that purchase of the real estate has been completed.
